(19) United States
(12) Patent Application Publication
(10) Pub. No.: US 2020/0386010 A1
(43) Pub. Date: Dec. 10, 2020

(54) REFRIGERATOR AND DOOR LOCK FOR REFRIGERATOR

(71) Applicant: BSH HAUSGERAETE GMBH, MUENCHEN (DE)

(72) Inventors: PING LV, NANJING (CN); XUN WANG, NANJING (CN); CHUAN ZHANG, NANJING (CN)

(21) Appl. No.: 16/889,912

(22) Filed: Jun. 2, 2020

(30) Foreign Application Priority Data
Jun. 4, 2019 (CN) 201910480526.7

(51) Int. Cl. E05B 65/00; F25D 23/02; E05B 17/00

(52) U.S. Cl. CPC E05B 65/0042; F25D 23/028; E05B 15/04; E05Y 2900/31; E05B 17/0041

(57) ABSTRACT

A refrigerator has a door lock. The refrigerator further includes a main body having a storage compartment, a first door, and a second door. The first door is disposed in front of the main body to open or close the storage compartment, and the first door has an opening. The second door is configured to open or close the opening from a front of the first door. The refrigerator includes the door lock configured to lock the two doors. The door lock includes a hook member mounted to one of the first and second doors, and a locking unit mounted to the other one of the first and second doors to restrain or release the hook member. The refrigerator has an anti-unlocking device, the anti-unlocking device is triggered when the first door hits the main body due to being closed, to prevent the locking unit from releasing the hook member.

### CROSS-REFERENCE TO RELATED APPLICATION

This application claims the priority, under 35 U.S.C. § 119, of Chinese patent application CN 201910480526, filed Jun. 4, 2019; the prior application is herewith incorporated by reference in its entirety.

### BACKGROUND OF THE INVENTION

### Field of the Invention

Embodiments of the present invention relate to a refrigerator and a door lock for the refrigerator.

A refrigerator is used to store food in a low-temperature environment. The refrigerator includes a main body provided with a storage compartment and a door for closing or opening the storage compartment. The door may be rotatably movable relative to the main body, or slidably move like a drawer.

In order to improve user experience of the refrigerator, the refrigerator may include a first door having an opening and a second door that may close or open the opening in front of the first door. The first door and the second door may be selectively locked or released through a locking mechanism for simultaneous movement or separate movement. A conventional door lock system includes a hook member and a latch for restraining or releasing the hook member. The hook member is alternately restrained or released by the latch by pushing one of the hook members and the latch to the other. When the hook member and the latch accidentally move toward each other, the hook member and the latch may be unlocked. For example, if the user forcibly closes the door so that the first door hits the main body and stops moving, the first door and the second door that are originally locked may be accidentally unlocked because the second door still has a motion inertia toward the main body.

### SUMMARY OF THE INVENTION

An objective of embodiments of the present invention is to provide an improved refrigerator and a door lock for a refrigerator.

Another objective of embodiments of the present invention is to provide a refrigerator and a door lock for a refrigerator that facilitates improvement of user experience.

Still another objective of embodiments of the present invention is to provide an improved reliable door lock and a refrigerator having such a door lock.

One aspect of embodiments of the present invention relates to a refrigerator. The refrigerator includes a main body having a storage compartment. a first door disposed in front of the main body to open or close the storage compartment, the first door having an opening, and a second door configured to open or close the opening from a front of the first door. A hook member is mounted to one of the first door and the second door. A locking unit is mounted to the other one of the first door and the second door to restrain or release the hook member. An anti-unlocking device is adapted to move when the first door hits the main body due to being closed, to prevent the locking unit from releasing the hook member.

The anti-unlocking device is set to be triggered to prevent the locking unit from releasing the hook member when the first door hits the main body due to being closed, the first door and the second door may be prevented from being accidentally unlocked when closed, facilitating improvement of user-friendliness of the refrigerator.

In one or more embodiments, the anti-unlocking device includes a movable member that moves relative to the locking unit and that is triggered when the first door hits the main body due to being closed. The movable member may move relative to the locking unit due to an inertial effect or a damper that moves under an external force.

In one or more embodiments, the anti-unlocking device is configured to be triggered under the action of inertia when the first door hits the main body due to being closed to move relative to the locking unit to prevent the locking unit from releasing the hook member. Therefore, the anti-unlocking device is triggered through an inertial difference between the first door and the second door at the moment of closing the door, which is not only easy to identify a scenario in which the first door and the second door are accidentally unlocked, but also very reliable. For the operation of the door lock, the user does not have to adopt additional door opening/closing measures, which may be expected.

In one or more embodiments, the anti-unlocking device includes a weight portion, the weight portion being adapted to move toward the main body under the action of inertia. A weight portion is added to increase sensitivity of the anti-unlocking device to detection of the first door and the second door being closed quickly by the user.

In one or more embodiments, the anti-unlocking device includes a blocking portion, the blocking portion being configured to operate driven by the weight portion to prevent the locking unit from releasing the hook member.

In one or more embodiments, the anti-unlocking device and the locking unit are located in the first door, and the blocking portion and the weight portion move in opposite directions.

In one or more embodiments, when the first door hits the main body, the weight portion moves toward the main body, and the blocking portion driven by the weight portion moves away from the body to prevent the latch from releasing the hook member.

In one or more embodiments, the anti-unlocking device and the locking unit are located in the second door, and the blocking portion and the weight portion move in the same direction.

In one or more embodiments, the anti-unlocking device includes a swing rod, and a weight portion is provided at an end of the swing rod to move under the action of inertia to drive the swing rod to move when the first door is closed and hits the main body.

In one or more embodiments, the locking unit includes a locking cam that may rotate, the locking cam being adapted to restrain the hook member when being in a first position, and the locking cam being adapted to release the hook member when being in a second position. The locking unit includes a locking rod for selectively positioning the locking cam in the first position or the second position, and the locking cam has a first stop portion and a second stop portion, the first stop portion being configured to restrain the locking rod to cause the locking cam to be in the first position, and the second stop being configured to restrain the locking rod to cause the locking cam to be in the second position.

In one or more embodiments, the anti-unlocking device prevents the first stop portion from releasing the locking rod when the first door hits the main body due to being closed.

In one or more embodiments, during the movement of the locking cam from the first position to the second position, the locking rod moves relative to the locking cam along a first path located on the locking cam, and when the first door hits the main body when closed, the blocking portion of the anti-unlocking device moves into or near the first path to prevent the locking rod from releasing the lock cam.

In one or more embodiments, when the first door hits the main body, the anti-unlocking device is adapted to apply, to the second door, a force that points from the first door to the second door, or apply, to the first door, a force that points from the second door to the first door.

In one or more embodiments, the anti-unlocking device includes at least one damper mounted to the first door or the second door, when the first door hits the main body in a case that the hook member is restrained by the locking unit, the damper applying a damping force to at least one of the second door and the first door.

In one or more embodiments, the anti-unlocking device is mounted to the locking unit.

Another aspect of the embodiments of the present invention relates to a refrigerator. The refrigerator includes a main body having a storage compartment and a first door disposed in front of the main body to open or close the storage compartment, the first door having an opening. A second door is configured to open or close the opening from a front of the first door. A hook member is mounted to one of the first door and the second door. A locking unit is mounted to the other one of the first door and the second door to restrain or release the hook member and a swing rod mechanism is adapted to be triggered when the first door hits the main body, to prevent the locking unit from releasing the hook member.

Still another aspect of the embodiments of the present invention relates to a refrigerator. The refrigerator includes a main body having a storage compartment, a first door disposed in front of the main body to open or close the storage compartment, the first door having an opening, and a second door configured to open or close the opening from a front of the first door. A hook member is mounted to one of the first door and the second door. A locking unit is mounted to the other one of the first door and the second door to restrain or release the hook member and a damper is disposed between the first door and the second door. When the hook member is restrained by the locking unit, the damper is adapted to apply, to the first door or the second door when the first door hits the main body, a damping force that makes the two doors face away from each other.

In one or more embodiments, when the first door and the second door are locked, the damper installed at the first door is in contact with the second door, and/or the damper installed at the second door is in contact with the first door. In this way, an anti-unlocking effect of the damper is enhanced.

The opening in the first door may be an opening in the form of a pass through, e.g. for accessing via this opening the storage compartment. The opening might also be a formed by an access opening of an auxiliary storage compartment, e.g. a trough or tub, whereas this access opening can be closed or opened by the second door. A rear wall of the auxiliary storage compartment, e.g. a bottom wall of the trough or tub, prevents access and/or exchange of air between the auxiliary storage compartment and the storage compartment.

Yet another aspect of the embodiments of the present invention relates to a door lock for a refrigerator. The door lock includes a hook member and a locking unit configured to restrain or release the hook member. The hook member and the locking unit are moved toward each other to alternately cause the locking unit to restrain and release the hook member. An anti-unlocking device is adapted to be triggered when the locked hook member and the locking unit move toward each other under the action of inertia, to prevent the locking unit from releasing the hook member.

In one or more embodiments, the anti-unlocking device is adapted to be triggered under the action of inertia to cause a blocking portion to move to a position that prevents the locking unit from releasing the hook member.

In one or more embodiments, the anti-unlocking device includes a swing rod, one end of the swing rod having a weight portion, the weight portion moving under the action of inertia to drive the blocking portion to prevent the locking unit from releasing the hook member.

In one or more embodiments, the anti-unlocking device includes a damper mounted to the locking unit, the damper being adapted to generate, due to a force when the hook member and the locking unit are in a locked state, a force that causes the hook member and the locking unit to face away from each other.

The features disclosed in connection with the refrigerator as described above having an anti-unlocking device may be combined with this door lock for a refrigerator.

Yet another aspect of the embodiments of the present invention relates to a door lock for a refrigerator. The door lock includes a hook member and a locking unit configured to restrain or release the hook member. The locking unit and the hook member are moved toward each other to cause the locking unit to restrain or release the hook member. A damper is provided and adapted to generate, due to a force when the hook member and the locking unit are in a locked state, a force that causes the hook member and the locking unit to face away from each other.

Other features which are considered as characteristic for the invention are set forth in the appended claims.

Although the invention is illustrated and described herein as embodied in a refrigerator and a door lock for the refrigerator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic, partial three-dimensional view of a refrigerator according to an embodiment of the present invention;

FIG. 2 is a schematic, partial cross-sectional view of a first door and a second door of the refrigerator being closed but not locked according to an embodiment of the present invention;

FIG. 3 is a schematic, three-dimensional view of a hook member and a locking unit in a released state according to an embodiment of the present invention;

FIG. 4 is a schematic, partial cross-sectional view of the first door and the second door of the refrigerator in a locked state according to an embodiment of the present invention;

FIG. 5 is a schematic, three-dimensional view of the hook member and the locking unit in a locked state according to an embodiment of the present invention;

FIG. 6 is a schematic, partial cross-sectional view of the first door and the second door that are locked at a moment of hitting a main body according to an embodiment of the present invention;

FIG. 7 is a schematic, partial cross-sectional view of the first door and the second door of a refrigerator in a locked state according to another embodiment of the present invention;

FIG. 8 is a schematic, partial cross-sectional view of the first door and the second door that are locked at a moment of hitting a main body as shown in FIG. 7; and

FIG. 9 is a schematic, partial cross-sectional view of the first door and the second door of the refrigerator in a locked state according to still another embodiment of the present invention.

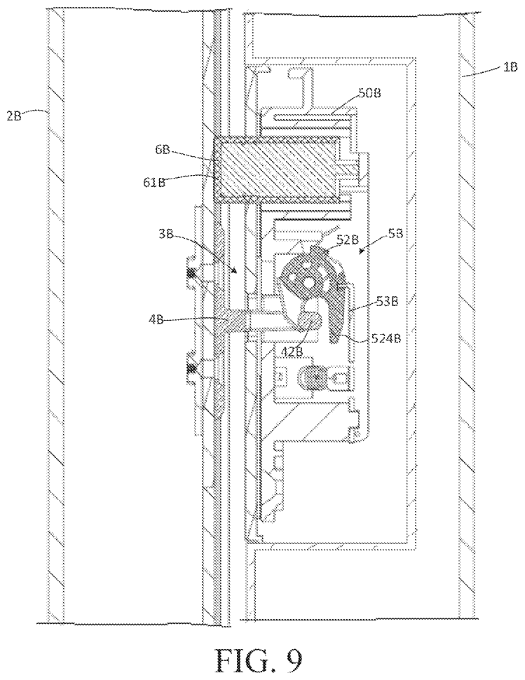

### DETAILED DESCRIPTION OF THE INVENTION

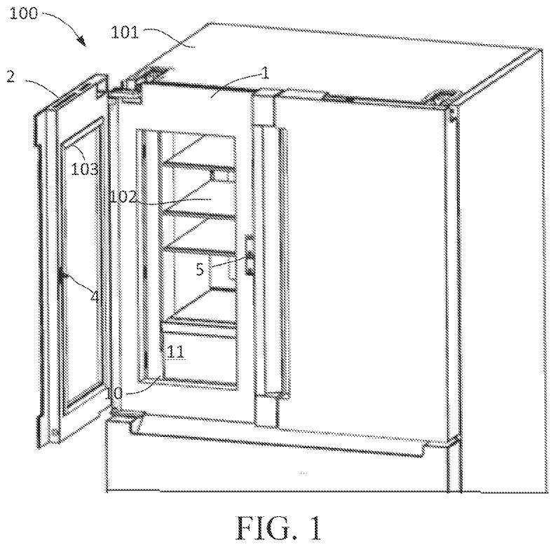

Referring now to the figures of the drawings in detail and first, particularly to FIG. 1 thereof, there is shown a schematic partial three-dimensional view of a refrigerator 100 according to an embodiment of the present invention. As shown in FIG. 1, the refrigerator 100 includes a main body 101 having a storage compartment 102. The storage compartment 102 may be a refrigerating compartment or a freezing compartment or a temperature change compartment.

The refrigerator 100 includes a first door 1 disposed in front of the main in body 101 to open or close the storage compartment 102. The first door 1 has an opening 10. The first door 1 may have a chamber 11 touchable through the opening 10. When the first door 1 is closed, the first door 1 is in contact with the main body 101.

The refrigerator 100 includes a second door 2 configured to open or close the opening 10 from a front of the first door 1.

The first door 1 and the second door 2 may be opened or closed respectively. In an exemplary embodiment, the first door 1 and the second door 2 may be rotatably moved relative to the main body 101, respectively. The first door 1 may rotate around a first hinge axis (not shown), and the second door 2 may rotate around a second hinge axis (not shown).

The refrigerator 100 includes a door lock 3 configured to selectively lock the first door 1 and the second door 2. The first door 1 and the second door 2 may move relative to the main body 101 while maintaining a locked state.

A seal ring 103 may be provided between the first door 1 and the second door 2 to reduce heat exchange between the outside and the refrigerator 100 through a gap between the first door 1 and the second door 2.

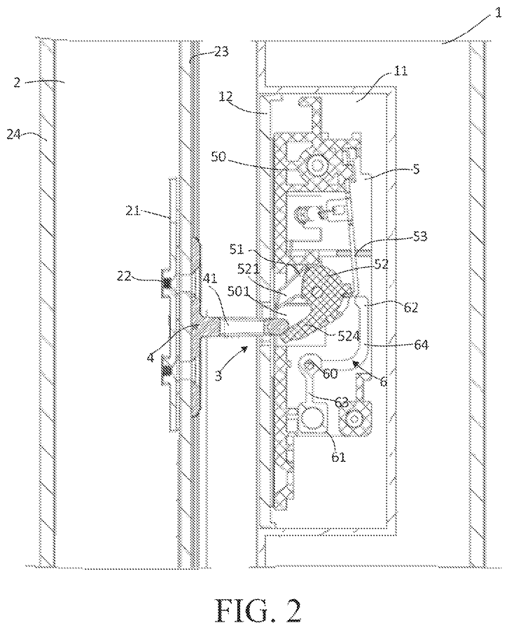

Referring to FIGS. 2 to 5 with reference to FIG. 1, the door lock 3 includes a hook member 4 mounted to a rear of the second door 2 and a locking unit 5 mounted to the first door 1. The locking unit 5 is configured to restrain or release the hook member 4 to lock or unlock the first door 1 and the second door 2.

The hook member 4 may protrude backward from a rear side of the second door 2. In one embodiment, the hook member 4 may have a locking hole 41.

The second door 2 includes a first wall 24 and a second wall 23 that are spaced apart, and the second wall 23 faces the first door 1.

The hook member 4 may be fixed to a second wall 23. The second door 2 may have a reinforcing member 21 extending along the second wall 23, and the hook member 4 is coupled to the reinforcing member 21 through a fixing member 22 (for example, a screw).

The locking unit 5 includes a latch 51 configured to restrain or release the hook member 4. The latch 51 may include a rotatable locking cam 52, and the locking cam 52 may rotate around a rotating shaft (not shown).

The latch 51 may further include a torsion spring (not shown) coupled to the locking cam 52 to provide the locking cam 52 with a torsion force.

The locking cam 52 includes a locking hook 521 for hooking with the hook member 4. The locking hook 521 protrudes from an outer peripheral surface of the locking cam 52. The locking cam 52 may further include an operation protrusion 524 spaced apart from the locking hook 521.

The first door 1 may have a mounting cavity 11 for accommodating the locking unit 5. After the locking unit 5 is mounted, the mounting cavity 11 may be closed using a cover 12.

The locking unit 5 may include a housing 50 fixed to the first door 1, the housing 50 having a hole 501 touchable from a front side of the first door 1, and the locking cam 52 is touchable through the hole 501.

The locking unit 5 and the hook member 4 may be alternately locked and unlocked in such a manner that one of the two is pushed toward the other to approach each other. For example, the second door 2 in which the hook member 4 is located is pressed, the hook member 4 drives the locking cam 52 to move, thereby locking or unlocking the hook member 4 and the locking cam 52.

In an exemplary embodiment, the second door 2 is pressed and pushed, so that the hook member 4 fixed at the rear of the second door 2 generates a certain stroke toward the locking unit 5, and the hook member 4 and the locking unit 5 are locked. If the hook member 4 is moved toward the locking unit 5 again, the hook member 4 and the locking unit 5 are unlocked.

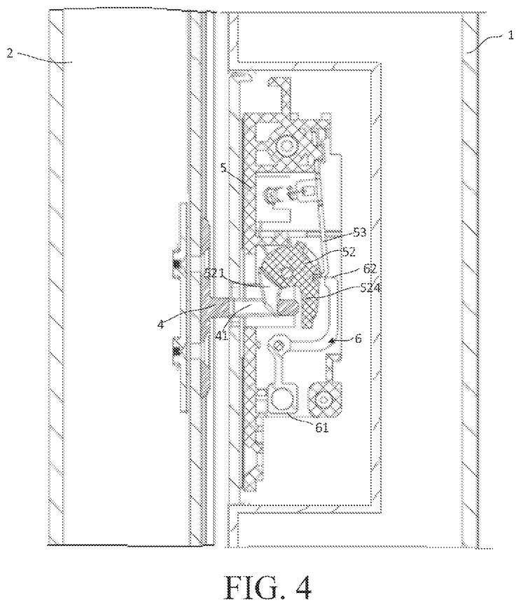

In an exemplary embodiment, as shown in FIG. 2, the hook member 4 extends into the hole 501, and when the hook member 4 continues to move toward the housing 50, the hook member 4 pushes an operation portion 524 of the locking cam 52 to cause the locking cam 52 to rotate and reach the first position (as shown in FIG. 4).

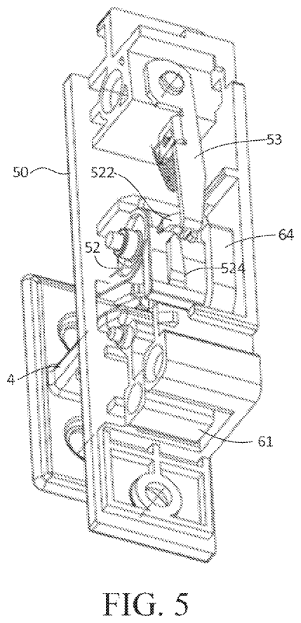

In the first position, as shown in FIG. 4 and FIG. 5, the locking hook 521 is located in the locking hole 41, and the latch 51 restrains the hook member 4. There is a spacing between an end of the hook member 4 and the operation portion 524.

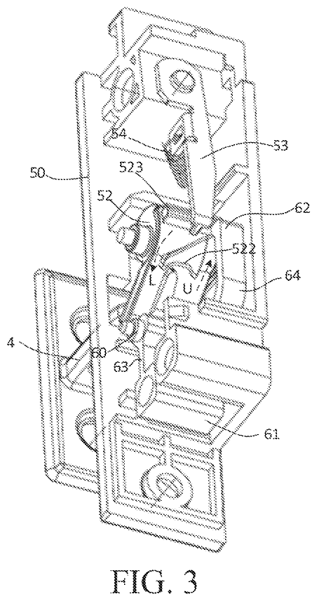

If a pressure is applied to the second door 2 again, the hook member 4 may push the operation portion 524 again, causing the locking cam 52 to rotate. When the locking cam 52 rotates to the second position (as shown in FIG. 2 and FIG. 3), the locking hook 521 exits the locking hole 41 to release the hook member 4, the hook member 4 exits from the hole 501, and the first door 1 and the second door 2 are unlocked.

The locking unit 5 may include a locking rod 53 configured to selectively position the locking cam 52 in the first position or the second position. The locking cam 52 may have a first stop portion 522 and a second stop portion 523. The first stop portion 522 is configured to restrain the locking rod 53 so that the locking cam 52 is in the first position (as shown in FIG. 5). The second stop portion 523 is configured to restrain the locking rod 53 so that the locking cam 52 is in the second position (as shown in FIG. 3).

When the locking cam 52 is pushed by the hook member 4 to move from the second position to the first position, the locking rod 53 leaves the second stop portion 523, moves along a first path L provided in the locking cam 52, and is engaged with the first stop portion 522. The locking cam 52 cannot continue to rotate, and the hook member 4 and the locking hook 521 cooperate to be locked.

When the hook member 4 moves forward again, the hook member 4 drives the locking cam 52 to rotate slightly so that the first stop portion 522 releases the locking rod 53, the locking cam 52 rotates from the first position to the second position under the action of the torsion spring, and the hook member 4 and the locking cam 52 release the constraint. The hook member 4 is pushed out of the hole 501 by the locking cam 52.

In this process, the locking rod 53 relatively slides along a second path U on the locking cam 52 until the locking rod 53 is positioned at the second stop portion 523, and the locking cam 52 may be prevented from further rotating.

When the first door 1 and the second door 2 are locked, if the user closes the door forcefully, the first door 1 will hit the main body 101 and stop moving, but the second door 2 that remains in contact with the first door 1 through the sealing ring 103 still has inertia toward a direction in which the door is closed. When the inertia reaches a certain extent, the second door 2 continues to move toward the first door 1 so that a movement amplitude of the second door 2 relative to the first door 1 is so large that the hook member 4 may reach and push the operation portion 524, so that the locking cam 52 unlocks the locking rod 53, causing the hook member 4 and the locking hook 521 to be released.

In order to avoid accidental unlocking of the first door 1 and the second door 2, the refrigerator 100 includes an anti-unlocking device 6, the anti-unlocking device 6 being triggered when the first door 1 hits the main body 101 when closed, to prevent the locking unit 5 from releasing the hook member 4.

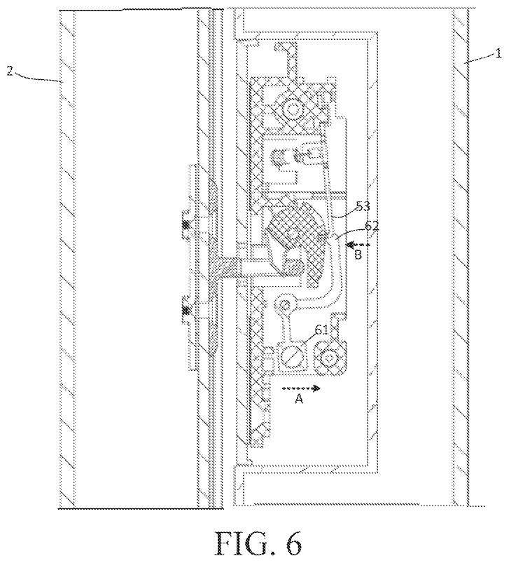

In an exemplary embodiment, referring to FIG. 6 with reference to FIGS. 2 to 5, the anti-unlocking device 6 is configured to be triggered by inertia when the first door 1 hits the main body 101 when closed to prevent the locking unit 5 from releasing the hook member 4. The anti-unlocking device 6 is adapted to be triggered when the locked hook member and the locking unit move toward each other under the action of inertia, to prevent the locking unit 5 from releasing the hook member 4.

The anti-unlocking device 6 may be configured to be triggered under the action of inertia to move relative to the locking unit 5 when the first door 1 hits the main body 101 when closed, to prevent the locking unit 5 from releasing the hook member 4.

The anti-unlocking device 6 may be mounted to the locking unit 5. The anti-unlocking device 6 includes a blocking portion 62. When the first door 1 hits the main body 101, the blocking portion 62 moves relative to the housing 50 of the locking unit 5 to prevent the locking cam 52 from releasing the hook member 4.

In one embodiment, the anti-unlocking device 6 may include a weight portion 61. When the first door 1 is forcibly closed, the weight portion 61 moves toward the main body 101 relative to the first door 1 under the action of inertia and drives the blocking portion 62 to move to prevent the latch 51 from releasing the hook member 4.

The weight portion 61 and the blocking portion 62 may move in opposite directions. As shown in FIG. 6, when the first door 1 hits the main body 101, the weight portion 61 continues to move toward the main body 101 under the action of inertia (as shown by an arrow A).

The blocking portion 62 is driven by the weight portion 61 to move toward the second door 2 (as shown by an arrow B) to prevent the latch 41 from releasing the hook member 4.

The anti-unlocking device 6 may be configured to prevent the first stop portion 522 from releasing the locking rod 53 through the blocking portion 62 when the first door 1 hits the main body 101. As shown in FIG. 5 and FIG. 6, the blocking portion 62 moves into the second path L or near the first path L to interfere with the locking rod 53 that is to leave the first stop portion 522, so that the locking rod 53 and the first stop portion 522 remain constrained.

In an exemplary embodiment, the anti-unlocking device 6 may include a swing rod mechanism. The swing rod mechanism includes a first rod portion 63 and a second rod portion 64. The first rod portion 63 and the second rod portion 64 may rotate around the rotating shaft 60 and are located on different sides of the rotating shaft 60A. The first rod portion 63 and the second rod portion 64 may be fixed together immovably. For example, the first rod portion 63 and the second rod portion 64 may be integrally formed.

There is a weight portion 61 at the end of the first rod portion 63. When the first door 1 is closed and hits the main body 101, the weight portion 61 may move relative to the first door 1 and drive the second rod portion 64 to move, thereby preventing the latch 51 from releasing the hook member 4 through the blocking portion 62 located at the second rod portion 64.

The first rod portion 63 may be located above the second rod portion 64. The first rod portion 63 may extend downward from the rotating shaft 60, and the second rod portion 64 may be located above the rotating shaft 60. The weight portion 61 may be located above the blocking portion 62. When the swing rod mechanism moves relative to the housing 50, the weight portion 61 and the blocking portion 62 move in opposite directions.

In one embodiment, the first rod portion 63 may be kept vertically downward under normal circumstances. The second rod portion 64 may be substantially L-shaped.

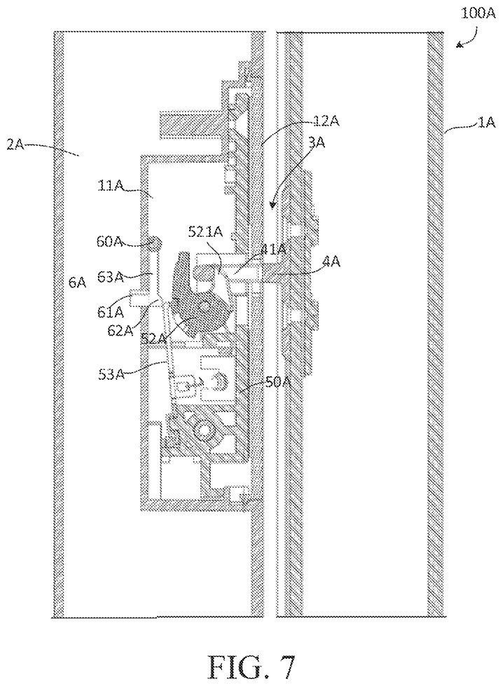

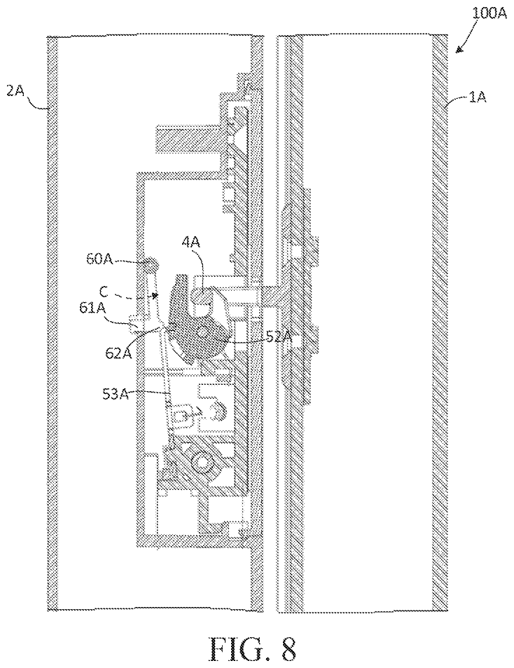

FIG. 7 and FIG. 8 are each a schematic partial cross-sectional view of a refrigerator 100A according to another embodiment of the present invention, where a main body is not shown. The second door 2A is located in front of a first door 1A to close an opening located in the first door 1A. When the first door 1A is closed, the first door 1A is in contact with the main body.

As shown in FIG. 7, a door lock 3A is provided between the first door 1A and the second door 2A to selectively lock or unlock the first door 1A and the second door 2A. In this embodiment, a locking unit 5A is provided on the second door 2A, and a hook member 4A is provided on the first door 1A.

The second door 2A may have a mounting cavity 11A for accommodating the locking unit 5A. The locking unit 5A may be fixed in the mounting cavity 11A through a housing 50A. After the locking unit 5A is fixed to the mounting cavity 11A, a cover 12A closes the mounting cavity 11A.

By pushing the second door 2A, the locking unit 5A moves toward the hook member 4 for physical contact and pressure application, thereby locking or unlocking the hook member 4A at the first door 1A and a latch of the locking unit 5A at the second door 2A. Specifically, a locking cam 52A and a hook member 4A are brought close together to physically apply a pressure, so that the locking cam 52A rotates and a locking hook 521A extends into or exits a locking hole 41A. A locking rod 53A is used to cooperate with a corresponding stop portion of the locking cam 52A to maintain the locking cam 52A in the first position or the second position. A working mode of the hook member 4A and the locking unit 5A may be the same as that in the previous embodiment, and details are not described herein.

This embodiment differs from the previous embodiment mainly in an anti-unlocking device 6A. In this embodiment, the anti-unlocking device 6A is located in the second door 2A. The anti-unlocking device 6A is configured to be triggered when the first door 1A and the second door 2A are forcibly and quickly closed when locked, to prevent the locking rod 53A from releasing the locking cam 52A.

The anti-unlocking device 6A may include a swing mechanism that moves relative to the second door 2A under the action of inertia when the first door 1A and the second door 2A are forcibly and quickly closed when locked.

The anti-unlocking device 6A may be mounted into the locking unit 5A. The anti-unlocking device 6A may include a swing rid 63A adapted to rotate around the rotating shaft 60A. The anti-unlocking device 6A may include a weight portion 61A located at the end of the swing rod 63A and a blocking portion 62A located on the same side of the weight portion 61A relative to the rotating shaft 60A. In one embodiment, the blocking portion 62A may be integrated into the weight portion 61A.

As shown in FIG. 7, the blocking portion 62A is closer to a front surface of the second door 2A than the locking rod 53A. In general, the swing rod 63A is located below the rotating shaft 60A. The swing lever 63A may extend substantially vertically downward.

Although there is a gasket between the second door 2A and the first door 1A, the second door 2A has inertia to continue moving toward the main body relative to the first door 1A blocked by the main body. The hook member 4A may apply a pressure to an operation portion of the locking cam 52A. In addition, the swing rod 63A with the weight portion 61A also continues to move toward the first door 1A under the action of inertia, as shown by an arrow Cin FIG. 8. The blocking portion 62A and the weight portion 61A move in a same direction. The blocking portion 62A moves toward the locking cam 52A relative to the second door 2A, to prevent the locking rod 53A from releasing the first stop portion of the locking cam 52A. In this way, the locking unit 5A and the hook member 4A may be prevented from being unlocked.

FIG. 8 is a schematic partial cross-sectional view of a refrigerator 100B according to another embodiment of the present invention. As shown in FIG. 8, the refrigerator 100B includes a first door 1B connected to a main body (not shown in FIG. 8) and a second door 2B located in front of the first door 1B to selectively touch an opening (not shown) in the first door 1B.

The refrigerator 100B includes a door lock 3B configured to lock the first door 1B and the second door 2B. The door lock 3B is located between the first door 1B and the second door 2B, and includes a hook member 4B fixed to the second door 2B and a locking unit 5B fixed to the first door 1B.

The locking unit 5B and the hook member 4B may be alternately locked and unlocked in the same push-push manner as that in the foregoing embodiment. Therefore, a structure and a cooperation method of a latch 51B and the hook member 4B of the locking unit 5B may be the same as or similar to the previous embodiment, and the restraining and releasing methods of the locking cam 52B and the locking hook 53B may also be the same as the previous embodiment, and details are not described herein.

This embodiment differs from the previous embodiment mainly in an anti-unlocking manner for preventing the first door 1B and the second door 2B from being accidentally unlocked in a locked state due to the impact on the main body as a result of forcibly closing a door by a user.

There is an anti-unlocking device 6B between the first door 1B and the second door 2B, which is configured to be adapted to apply, to the second door 2B or the first door 1B, a force that makes the two doors face away from each other when the first door 1B and the second door 2B in the locked state hit the main body.

The anti-unlocking device 6B may include a damper 61B between the first door 1B and the second door 2B. The damper 61B is adapted to generate a damping force when pressed.

The damper 61B includes a movable member that may move under the action of an external force. The damper 61B may include a damping housing having a chamber, a damping medium located in the damping cavity, and a movable member movable relative to the damping housing.

In an exemplary embodiment, the damper 61B is provided at the first door 1B. If the first door 1B and the second door 2B are locked, if the second door 2B moves toward the first door 1B, the damper 61B applies, to the second door 2B, a force that points from the first door 1B to the second door 2B.

When the hook member 4B is restrained by the locking unit 5B (in this case, the locking cam 52B is in the first position), the damper 61B may be in contact with a door that the damper 61B faces. When the second door 2B is pushed toward the first door 1B to lock the two doors, the damping force of the damper 61B may be set not to prevent the first door 1B and the second door 2B from being locked, which may be about 10 N, for example.

When the first door 1B and the second door 2B are quickly closed by force to instantly hit the main body 101, the movable member of the damper 61B moves and the damping force instantly increases, to prevent the hook member 4B from erroneously driving the locking unit 5B to be unlocked as a result of continuous reduction of a distance between the first door 1B and the second door 2B. For example, the damping force of the damper 61B may be increased to more than 40 N. The force may prevent the first door 1B and the second door 2B in the locked state from causing the hook member 4B to drive the locking unit 5B to malfunction and release the locking due to the inertia of the second door 2B.

In an embodiment, when the locking cam 52B is in the first position and the hook member 4B is locked, there may be a small gap between the damper 61B and a door facing the damper 61B, as long as the gap between the damper 61B and the door facing the damper 61B is smaller than a gap between an end 42B of the hook member 4B and the operation portion 524B, to prevent the hook member 4B from pressing the operation portion 524.

A buffer pad may be provided at the end of the damper 61B.

The damper 61B may be mounted to the first door 1B or the second door 2B separately from the hook member 4B or the locking unit 5B. For example, the damper may be mounted to a suitable position such as an edge region of the first door 1B or the second door 2B.

In an exemplary embodiment, the damper 61B is integrated into the locking unit 5B. A housing 50B of the lock unit 5B has a mounting groove 501B configured to mount the damper 61B. The damper 61B protrudes outside the mounting groove 501B.

In the embodiment in which the damper 61B is mounted to the first door 1B, the damper 61B protrudes from a front surface of the first door 1B.

The damper 61B is disposed between the first door 1B and the second door 2B, when the user closes the door forcefully, the damper 61B applies resistance to the first door 1B and/or the second door 2B, thereby preventing the second door 2B and the first door 1B from being accidentally unlocked due to a decreased spacing at the moment when the first door 1B hits the main body.

There may be at least one damper between the first door 1B and the second door 2B. At least one of the first door 1B and the second door 2B may be provided with at least one damper. When the user closes the door forcefully, the damper located on one door exerts a damping force on the other door to prevent the two doors from being accidentally unlocked due to inertia.

In the foregoing embodiment, both the first door and the second door may rotate around a rotating shaft extending in a vertical direction. It should be understood that the embodiments of the present invention are also applicable to the first door and the second door that respectively surround the rotating shaft extending in different directions. In addition, the door lock of the embodiment of the present invention may also be applied between the first door and the second door that may slide like a drawer.

In the foregoing embodiment, the anti-unlocking device respectively includes a swing rod mechanism and a damper. It should be understood that in other embodiments, the anti-unlocking device may include both a swing rod mechanism and a damper to enhance reliability of the anti-unlocking device. The anti-unlocking device is configured to be triggered under the action of inertia to move relative to the locking unit when the first door hits the main body due to being closed, to prevent the locking unit from releasing the hook member. The anti-unlocking device further includes at least one damper mounted to the first door or the second door, and when first door hits the body in a case that the hook member is restrained by the locking unit, the damper applies a damping force to at least one of the second door and the first door. A double anti-unlocking device is used to further reduce a possibility of accidental unlocking of the door lock.

1. A refrigerator, comprising:
a main body having a storage compartment;
a first door disposed in front of said main body to open or close said storage compartment, said first door having an opening formed therein;
a second door configured to open or close said opening from a front of said first door;
a hook member mounted to one of said first door and said second door;
a locking unit mounted to the other one of said first door and said second door to restrain or release said hook member; and
an anti-unlocking device adapted to be triggered when said first door hits said main body due to being closed, to prevent said locking unit from releasing said hook member.

2. The refrigerator according to claim 1, wherein said anti-unlocking device has a movable member that moves relative to said locking unit and is triggered when said first door hits said main body due to being closed.

3. The refrigerator according to claim 1, wherein said anti-unlocking device is configured to be triggered under an action of inertia when said first door hits said main body due to being closed to move relative to said locking unit, to prevent said locking unit from releasing said hook member.

4. The refrigerator according to claim 1, wherein said anti-unlocking device has a weight portion, said weight portion being adapted to move toward said main body under an action of inertia.

5. The refrigerator according to claim 4, wherein said anti-unlocking device contains a blocking portion, said blocking portion being configured to operate driven by said weight portion to prevent said locking unit from releasing said hook member.

6. The refrigerator according to claim 5, wherein:
said anti-unlocking device and said locking unit are disposed in said first door, and said blocking portion and said weight portion move in opposite directions; or
said anti-unlocking device and said locking unit are disposed in said second door, and said blocking portion and said weight portion move in a same direction.

7. The refrigerator according to claim 1, wherein said anti-unlocking device contains a swing rod, a weight portion being provided at an end of said swing rod to move under an action of inertia when said first door is closed and hits said main body, to drive said swing rod to move.

8. The refrigerator according to claim 5, wherein;
said locking unit contains a locking cam that may rotate, said locking cam is adapted to restrain said hook member when being in a first position, and said locking cam is adapted to release said hook member when being in a second position; and
said locking unit contains a locking rod for selectively positioning said locking cam in the first position or the second position, said locking cam having a first stop portion and a second stop portion, said first stop portion being configured to restrain said locking rod to cause said locking cam to be in the first position, and said second stop being configured to restrain said locking rod to cause said locking cam to be in the second position.

9. The refrigerator according to claim 8, wherein said anti-unlocking device and said locking rod interfere with each other when said first door hits said main body due to being closed, to prevent said first stop portion from releasing said locking rod.

10. The refrigerator according to claim 8, wherein during movement of said locking cam from the first position to the second position, said locking rod moves relative to said locking cam along a first path located on said locking cam, and when said first door hits said main body when closed, said blocking portion of said anti-unlocking device moves into or near the first path to prevent said locking rod from releasing said lock cam.

11. The refrigerator according to claim 1, wherein when said first door hits said main body, said anti-unlocking device is adapted to apply, to said second door, a force that points from said first door to said second door, or apply, to said first door, a force that points from said second door to said first door.

12. The refrigerator according to claim 1, wherein said anti-unlocking device contains at least one damper mounted to said first door or said second door, when said first door hits said main body in a case that said hook member is restrained by said locking unit, said damper applying a damping force to at least one of said second door and said first door.

13. The refrigerator according to claim 1, wherein said anti-unlocking device is mounted to said locking unit.

14. A refrigerator, comprising:
a main body having a storage compartment;
a first door disposed in front of said main body to open or close said storage compartment, said first door having an opening formed therein;
a second door configured to open or close said opening from a front of said first door;
a hook member mounted to one of said first door and said second door;
a locking unit mounted to the other one of said first door and said second door to restrain or release said hook member; and
a damper disposed between said first door or said second door, when said hook member is restrained by said locking unit, said damper being adapted to apply, to said first door or said second door when said first door hits said main body, a damping force that makes said first and second doors face away from each other.

15. A door lock for a refrigerator, the door lock comprising:
a hook member;
a locking unit configured to restrain or release said hook member, said hook member and said locking unit being moved toward each other to alternately cause said locking unit to restrain and release said hook member; and
an anti-unlocking device adapted to be triggered when said locked hook member and said locking unit move toward each other under an action of inertia, to prevent said locking unit from releasing said hook member.

16. The door lock according to claim 15, wherein said anti-unlocking device has a blocking portion and said anti-unlocking device is adapted to be triggered under an action of inertia to cause said blocking portion to move to a position that prevents said locking unit from releasing said hook member.

17. The door lock according to claim 16, wherein said anti-unlocking device contains a swing rod, one end of said swing rod having a weight portion, said weight portion moving under an action of inertia to drive said blocking portion to prevent said locking unit from releasing said hook member.

18. The door lock according to claim 15, wherein said anti-unlocking device contains a damper mounted to said locking unit, said damper being adapted to generate, due to a force when said hook member and said locking unit are in a locked state, a force that causes said hook member and said locking unit to face away from each other.
